(19) United States
(12) Patent Application Publication
(10) Pub. No.: US 2008/0134190 A1
(43) Pub. Date: Jun. 5, 2008

(54) Method and Apparatus of Resource Access Synchronization in a Basic Input and Output System of a Computer System

(75) Inventors: Yuanhao Sun, Shanghai (CN); Ke Yu, Shanghai (CN); Yubo Zhao, Shanghai (CN); Lechong Chen, Shanghai (CN)

Correspondence Address: LAWRENCE CHO;C/O PORTFOLIOIP, P. O. BOX 52050, MINNEAPOLIS, MN, 55402, US

(73) Assignee: INTEL CORPORATION, Santa Clara, CA (US)

(21) Appl. No.: 10/561,535

(22) PCT Filed: Aug. 25, 2004
(86) PCT No.: PCT/CN04/00984

§ 371 Date: Dec. 20, 2005

(51) Int. Cl. G06F 9/50

(52) U.S. Cl. 718/104

(57) ABSTRACT

A basic input and output system (BIOS) for a computer system includes a main engine to call and run routines. Some of the routines require resource accesses. A synchronization module is provided to synchronize the resource accesses. The synchronization module allows concurrent resource accesses to different resources. A method of synchronizing resource accesses in a basic input and output system of a computer system is also described.

### TECHNICAL FIELD

Embodiments of the present invention pertain to computer initialization firmware. More specifically, embodiments of the present invention relate to synchronizing data and/or resource accesses within a Basic Input and Out System (BIOS) of a computer system.

### BACKGROUND

A personal computer typically employs a BIOS program to initialize the computer. The BIOS also manages data flow between an operating system (OS) and various peripheral devices (e.g., hard disk, keyboard, cursor control device, display, and printer) of the computer. The BIOS is typically stored in a non-volatile memory, and is accessed by a processing unit (e.g., microprocessor) of the computer during initialization.

The BIOS is platform specific, meaning it is specific to particular processor architecture. This makes it rather difficult for independent software developers to expand its functionalities. To overcome this, a new standard known as Extensible Firmware Interface (EFI) (i.e., EFI 1.10 specification, published Jan. 7, 2003) has been introduced. The EFI standard defines an OS-BIOS interface that is not specific to any processor architecture. The interface includes data tables that contain platform-related information and EFI boot and runtime services that are available to the OS and its loader. The EFI interfaces with an EFI-based BIOS having EFI drivers and other routines. The EFI-based BIOS then interfaces with platform specific firmware and hardware of the computer.

The EFI-based BIOS adopts a Task Privilege Level (TPL) mechanism to provide synchronization for data or resource access by programs or routines within the EFI-based BIOS. Using the TPL synchronization mechanism, all the routines and data regions are assigned to different task privilege levels. A data region at a specific privilege level can only be accessed by routines at the same or higher privilege level. A routine can raise its current privilege level to a higher level before accessing a data region in order to protect that data region from being accessed by another routine at a privilege level lower than the raised privilege level. In addition, a routine running at a specific privilege level can be preempted by routines running at privilege levels higher than that specific privilege level. In other words, TPL is a shared variable.

While this prior approach provides the EFI-based BIOS with a basic synchronization mechanism, it has some significant drawbacks. One of the drawbacks is that the TPL-dependent synchronization mechanism is very coarse-grained. If a routine wants to access a data region, it has to raise its TPL to a certain level (e.g., TPLO), blocking any other routine running at a privilege level lower than or equal to the that privilege level from accessing the same data region, even though these routines actually do not want to access the same data region. As a result, the performance of the EFI-based BIOS is negatively impacted. This is illustrated in FIG. 1. In FIG. 1, the critical code 1 means a first routine accessing a first data region and the critical code 2 means a second routine different from the first routine accessing a second data region different from the first data region. When the critical code 1 raises its TPL above the privilege level of the critical code 2 and that of the normal codes l and 2 to access the first data region, all other codes are blocked on TPL. Only after the critical code 1 restores its privilege level to the original level prior to the raise, can the critical code 2 then access the second data region. Both the normal codes 1 and 2 are blocked on TPL throughout the operation, even though they do not require access to either the first or the second data region. Moreover, in order to ensure mutual exclusion (i.e., that no other routine can access the same data region), the routine may have to raise the privilege level to the highest level defined in the EFI-based BIOS. This further leads to even more performance loss.

Another drawback is that the prior TPL-dependent mechanism also does not support multiple data accesses to several data regions at the same time. This limitation means that when one routine needs to access, for example, two data regions at the same time, the routine has to release the control of the first data region before it is allowed to access the second data region (i.e., restore the TPL before going to second data). If the TPL of the second data region is lower than the first one, entering the second data region without exiting the first one actually breaks the assumption of this TPL mechanism that code running at lower privilege level can not access the data region at the higher privilege level.

Thus, what is needed is an improved synchronization mechanism that overcomes the drawbacks of the prior TPL-dependent synchronization mechanism.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 shows the operation of a prior art TPL-dependent synchronization mechanism in an EFI-based BIOS.

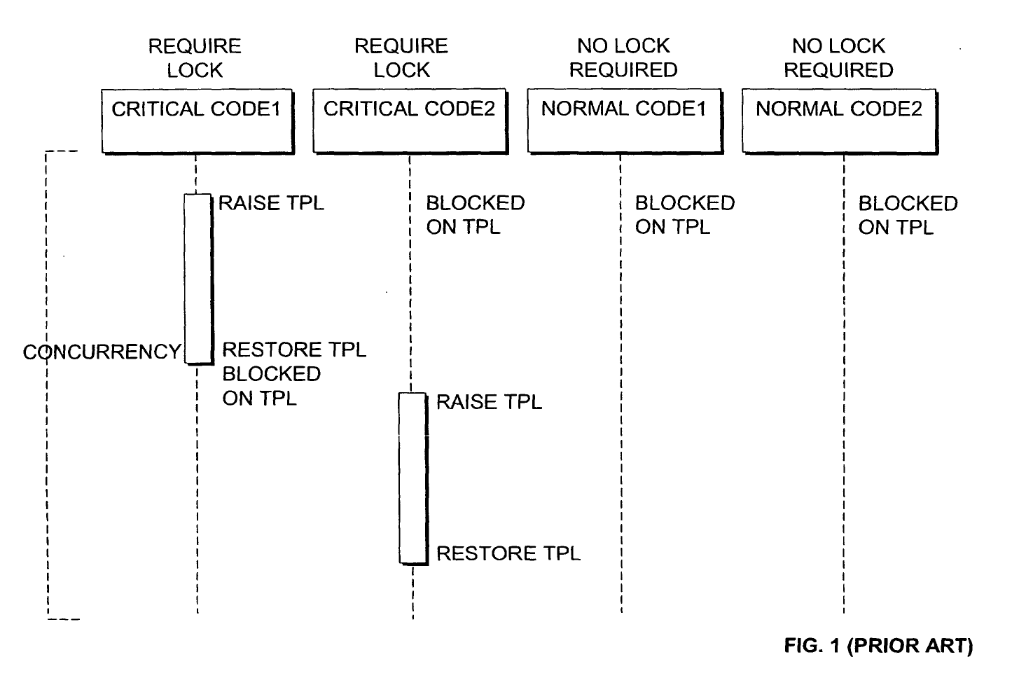

FIG. 2 is a block diagram showing an exemplary architecture of a computer system having an EFI-based BIOS with a synchronization module that synchronizes resource accesses within the EFI-based BIOS in accordance with an embodiment of the present invention.

FIG. 3 shows the operation of the synchronization module of FIG. 2.

FIG. 4 shows the layout of an access indicator storage that stores all access indicators for all the resources that are synchronized by the synchronization module of FIG. 2 in accordance with an embodiment of the present invention.

FIG. 5 is a flowchart diagram showing the synchronization process of the synchronization module of FIG. 2 in accordance with an embodiment of the present invention.

FIG. 6 is a flowchart diagram showing the process of a WAIT synchronization operation of the synchronization process of FIG. 5.

FIG. 7 is a flowchart diagram showing the process of a BUSY_WAIT synchronization operation of the synchronization process of FIG. 5.

FIG. 8 is a flowchart diagram showing the process of a TRY_LOCK synchronization operation of the synchronization process of FIG. 5.

FIG. 9 is a flowchart diagram showing the process of a SIGNAL operation of the synchronization process of FIG. 5

FIG. 10 is a flowchart diagram of an exemplary process of the synchronization process of FIG. 5 in handling network (e.g., TCP/IP protocol) communications.

### DETAILED DESCRIPTION

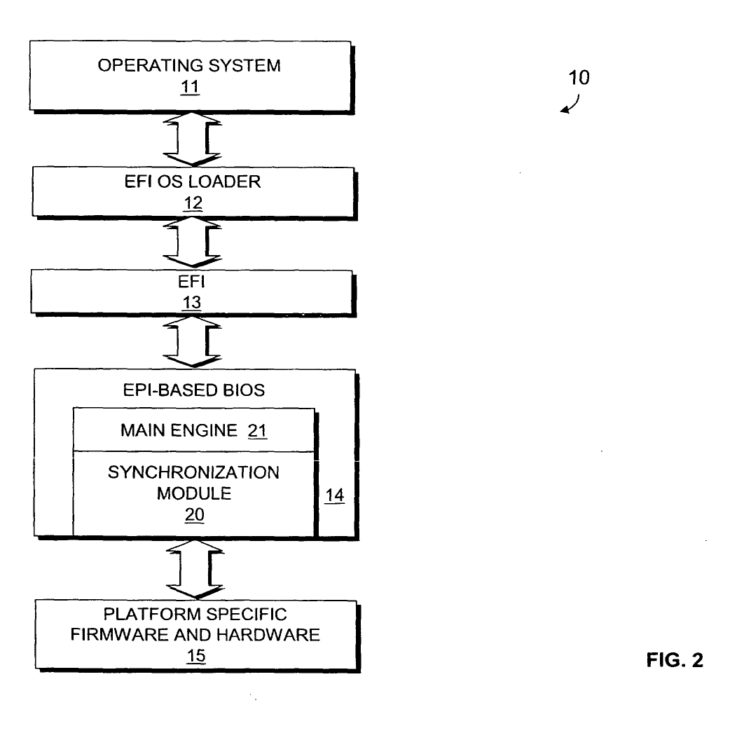

FIG. 2 shows a computer system 10 that includes an EFI-based BIOS 14 having a synchronization module 20 that implements an embodiment of the present invention. In accordance with an embodiment of the present invention, the synchronization module 20 synchronizes resource accesses by program routines within the EFI-based BIOS 14 in such a way that concurrent accesses to different resources are allowed. In addition, the synchronization module 20 allows a resource to be accessed by multiple program routines at the same time. This means that the synchronization module 20 of FIG. 2 allows non-competing resource accesses to be conducted concurrently. Moreover, the synchronization module 20 allows program routines that do not require resource accesses to be running concurrently with the resource access operations. In doing so, the performance of the computer system 10 is significantly increased because the synchronization module 20 only blocks competing resource access operations without affecting (1) non-competing resource access operations and (2) non-resource access operations.

Here, the term resource refers to any hardware resource (e.g., memory, buffer, hard disk, removable non-volatile memory store, printer) of the computer system 10. FIG. 2 does not show the memory, buffer, hard disk, removable non-volatile memory store, or printer, but these components are included in a platform-specific firmware and hardware 15 (FIG. 2) of the computer system 10. In addition, the term resource can also refer to a data file (or a variable) stored in a memory region, or a particular area within a memory, a buffer, or a hard drive that stores data. The data file can be a shared variable.

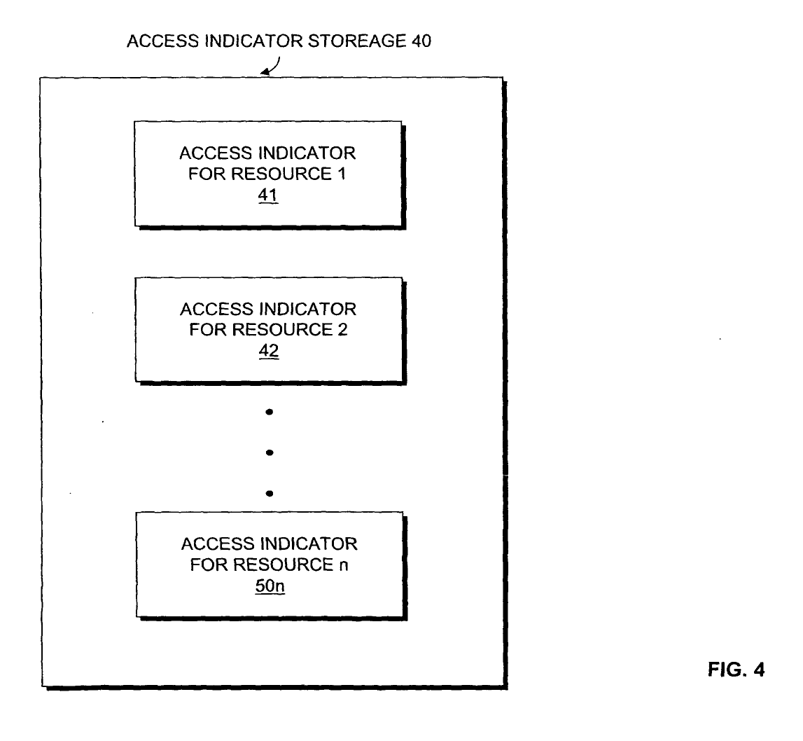

As will be described in more detail below and in accordance with one embodiment of the present invention, the synchronization module 20 first associates an access indicator (e.g., access indicator 41 in FIG. 4) with a resource. In an embodiment, one access indicator is only associated with one resource and each resource of the computer system 10 only has one associated access indicator.

The access indicator indicates the access status of the associated resource. The access indicator has an initial value that indicates the number of accesses the associated resource can receive at a given time. In an embodiment, when the value of the access indicator is equal to ZERO, it indicates that the associated resource cannot be accessed at the time. When the value of the access indicator is equal to ONE, it indicates that the associated resource can only be accessed by one program routine at the time. If the value of the access indicator is equal to a value of THREE, then it indicates that the associated resource can be accessed by three program routines at the same time. Whenever the resource is accessed by a program routine, the value of the access indicator is decreased by the incremental value of ONE.

When a program routine within the BIOS 14 wants to access a resource, the synchronization module 20 first determines the current value of the associated access indicator of the resource. If the value is ZERO, the synchronization module 20 denies the access to the resource. If the value of the access indicator is ONE, then the synchronization module 20 decreases the value by ONE to ZERO and allows the requesting program routine to access the resource. The resource now cannot be accessed by any other program routine because its access indicator has reached ZERO.

If the value of the access indicator is at a value greater than ONE, then the synchronization module 20 just simply decreases the value by ONE and allows the requesting program routine to access the resource. In this case, the resource is not blocked (because its access indicator has not reached the value of ZERO) and can be accessed by other program routines. Because the access indicator is resource specific, other resource access operations and non-resource access operations are not affected by this resource access operation, thus achieving a greater degree of concurrency.

The value of the access indicator is restored (i.e., increased by the value of ONE) once the requesting program routine completes its resource access. The synchronization module 20 will be described in more detail below, also in conjunction with FIGS. 2-10.

Referring again to FIG. 2, the structure of the computer system 10 is shown. In one embodiment, the computer system 10 is a personal computer. Here, the term personal computer refers to a desktop personal computer, a notebook personal computer, a palm-top personal computer, and a personal digital assistant. Alternatively, the computer system 10 can be other type of computer systems. For example, the computer system 10 can be a workstation computer system, a mainframe computer system, a server computer system, or a supercomputer.

The computer system 10 includes an OS (Operating System) 11, an EFI OS loader 12, an EFI 13, and a platform specific firmware and hardware 15, in addition to the EFI-based BIOS 14. The OS 11 can be any known operating system. For example, the OS 11 can be a Linux-based operating system, or a Unix-based operating system.

The EFI OS loader 12 is used to launch or load the OS 11 (or at least a portion of the OS 11) into a memory (not shown in FIG. 2) of the computer system 10 from a hard disk (also not shown) that stores the OS 11. The EFI OS loader 12 can be any known EFI OS loader and therefore will not be described in more detail below. The EFI OS loader 12 interfaces with the EFI 13.

The EFI 13 is an open standard interface that is platform-independent. The EFI 13 is written in high level programming language (e.g., C). The EFI 13 is implemented in accordance with the EFI specification published by Intel Corporation of Santa Clara, Calif. However, the actual implementation of the EFI 13 may vary in many different ways.

The EFI 13 includes data tables (not shown in FIG. 2) that contain platform-related information. The EFI 13 also includes boot and runtime service calls that are available to the OS 11 and the loader 12. The EFI 13 can call or run EFI drivers that are located within the EFI-based BIOS 14. Each of the EFI drivers performs a designated system level operation (e.g., I/O operation)

The EFI 13 interfaces with the EFI-based BIOS 14 having the EFI drivers and other routines. The EFI-based BIOS 14 then interfaces with the platform specific firmware and hardware 15 of the computer system 10. The structure and operation of the EFI 13 will not be described in more detail below.

The platform-specific firmware and hardware 15 includes a number of platform-specific firmware and hardware components. For example, the platform-specific firmware and hardware 15 includes a processor that executes instructions of program routines. The processor may include an on-chip cache. The hardware 15 may also include a memory, a hard disk, a removable non-volatile memory store, a printer, a display, a network interface card, and a keyboard. In addition, the network interface card may include shared and unshared buffers. FIG. 2 does not show these components. Moreover, the platform-specific firmware and hardware 15 may include all other firmware and hardware components necessary for operating the computer system 10.

The EFI-based BIOS 14 is used to interface the EFI 13 with the platform-specific firmware and hardware 15 during initialization of the computer system 10. The EFI-based BIOS 14 includes a main engine 21 that includes the EFI drivers and other routines. Although FIG. 2 shows that the BIOS 14 is an EFI-based BIOS, the BIOS 14 may be other type of BIOS. For example, the BIOS 14 can be a non-EFI-based BIOS.

The main engine 21 of the EFI-based BIOS 14 handles many system initialization and input/output (I/O) routines. This function will not be described in more detail below. The main engine 21 of the EFI-based BIOS 14 includes many program routines. In particular and for the purpose of describing an embodiment of the present invention, the main engine 21 of the EFI-based BIOS 14 includes two types of program. One is referred to as EFI event handler routine and the other is non-EFI event handler routine (i.e., at APPLICATION TPL level). Both handlers may access resources within the platform-specific firmware and hardware 15 of the computer system 10.

To synchronize the resource accesses by the program routines within the BIOS 14, the EFI-based BIOS 14 includes the synchronization module 20. As described above, the synchronization module 20 synchronizes resource accesses by program routines within the EFI-based BIOS 14 in such a way that concurrent accesses to different resources are allowed. In addition, the synchronization module 20 allows a resource to be accessed by multiple program routines at the same time. Moreover, the synchronization module 20 allows program routines that do not require resource accesses to be running concurrently with the resource access operations.

The synchronization module 20 achieves the synchronization by associating an access indicator to each of the resources of the computer system 10. FIG. 4 shows an access indicator storage 40 that contains a number of access indicators 41-50n. Each of the access indicators 41-50n is associated with one resource, in one embodiment. This means that one access indicator is only associated with one resource and each resource of the computer system 10 only has one associated access indicator. For example and as can be seen from FIGS. 2 and 4, the access indicator 41 in FIG. 4 is associated with a resource 1 and the access indicator 50n is associated with a resource n. In an alternative embodiment, each access indicator can be associated with multiple resources.

Each access indicator indicates the access status of the associated resource. Each access indicator has an initial value that indicates the number of accesses the associated resource can receive at a given time. In an embodiment, when the value of the access indicator is equal to ZERO, it indicates that the associated resource cannot be accessed at the time. When the value of the access indicator is equal to ONE, it indicates that the associated resource can only be accessed by one program routine at the time. If the value of the access indicator is equal to a value of THREE, then it indicates that the associated resource can be accessed by three program routines at the same time. For example, when the value of the access indicator 50n is equal to ZERO, it indicates that the associated resource n cannot be accessed at the time. When the value of the access indicator 50n is equal to ONE, it indicates that the associated resource n can only be accessed by one program routine at the time. The synchronization module 20 manages the access indicators 41-50n.

When a program routine within the BIOS 14 wants to access a resource (e.g., the resource n), the synchronization module 20 employs one of three synchronization operations to synchronize the access operation. These synchronization operations include a WAIT operation, a BUSY_WAIT operation, and a TRY_LOCK operation. If the requesting program routine is an EFI event handler routine, then the synchronization module 20 employs the WAIT or TRY_LOCK operation to block the resource from being accessed by other asynchronous event handler. If the requesting program routine is a non-EFI event handler routine, then the synchronization module 20 employs the WAIT, BUSY_WAIT, or TRY_LOCK operation to block the resource from being accessed by other asynchronous event handler.

When a program routine within the BIOS 14 wants to access a resource (e.g., the resource n), the synchronization module 20 first determines the current value of the access indicator 50n. If the value is ZERO, the synchronization module 20 denies the access to the resource n. If the value of the access indicator is ONE, then the synchronization module 20 decreases the value by ONE to ZERO and allows the requesting program routine to access the resource n. The resource now cannot be accessed by any other program routine because its access indicator has reached ZERO.

If the value of the access indicator 50n is at a value greater than ONE, then the synchronization module 20 just simply decreases the value by ONE and allows the requesting program routine to access the resource n. In this case, the resource is not blocked (because its access indicator has not reached the value of ZERO) and can be accessed by other program routines. Because the access indicator is resource specific, other resource access operations and non-resource access operations are not affected by this resource access operation, thus achieving a greater degree of concurrency. The synchronization module 20 restores the value of the access indicator (i.e., increase the value by ONE) once the requesting program routine completes its resource access.

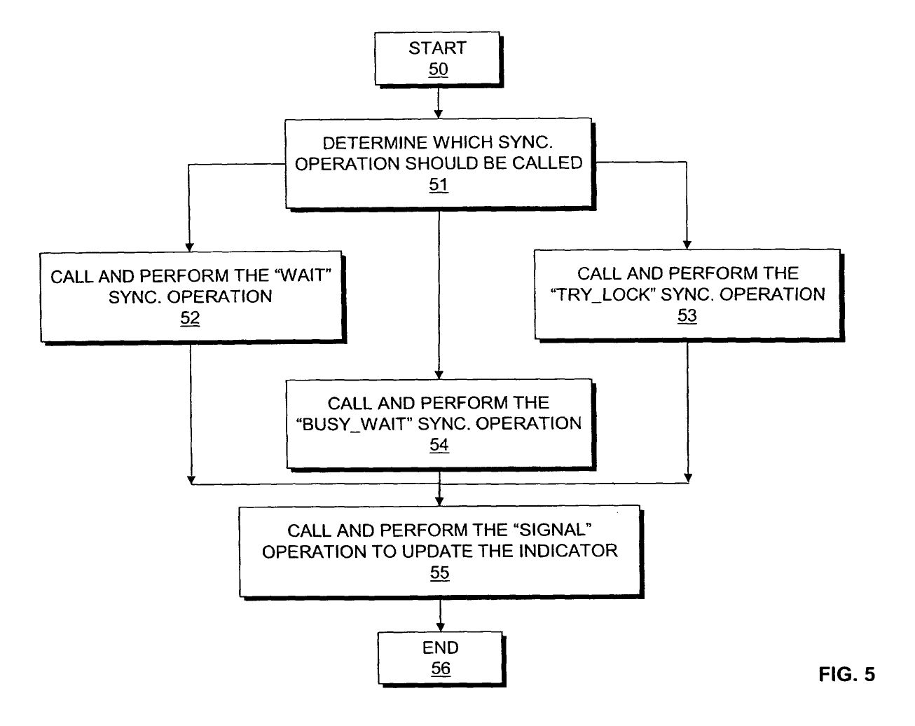

The synchronization module 20 can be implemented in software, firmware, or hardware form. In one embodiment, the synchronization module 20 is implemented in software. In another embodiment, the synchronization module 20 is implemented in firmware. The synchronization process of the synchronization module 20 is shown in FIG. 5, which will be described in more detail below.

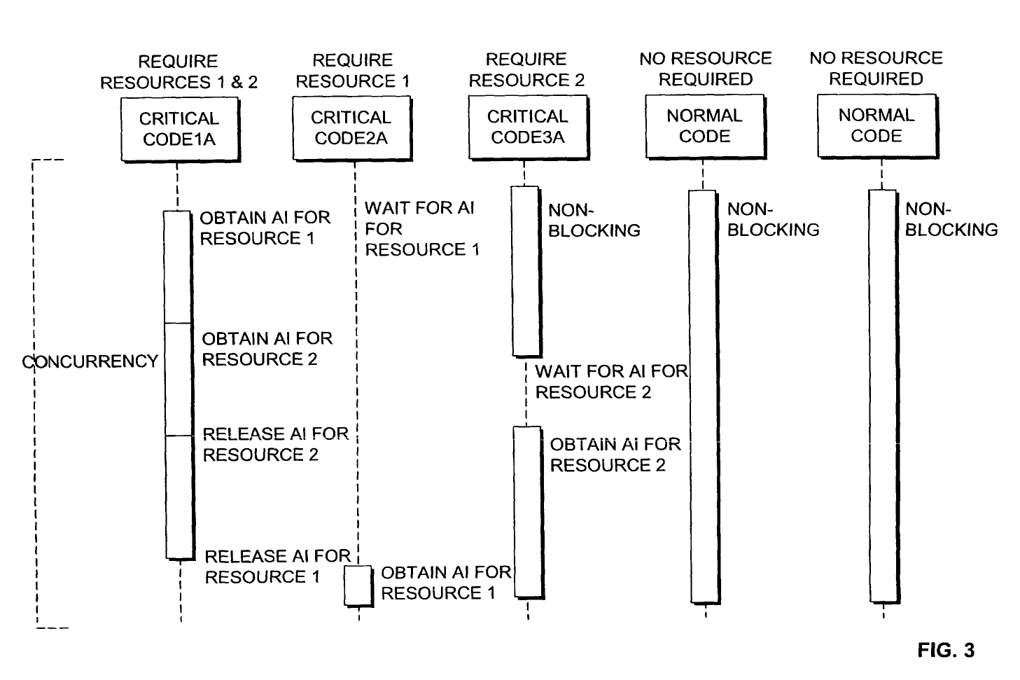

FIG. 3 shows the high degree of concurrency achieved by the synchronization module 20 of FIG. 2 in accordance with an embodiment of the present invention. As can be seen from FIGS. 3-4, critical code 1A requires access to the resource 1 and 2 while critical code 2A and critical code 3A each requires access to only the resource 1 or 2, respectively. In this case and as can be seen from FIG. 3, when the critical code 1A obtains or acquires the resource 1 through the access indicator 41 (FIG. 4), only the critical code 2A is blocked and there is no blocking as to the critical code 3A and other normal non-resource access codes. Both the critical codes 2A-3A are blocked only when the critical code 1A acquires the resource 2 while still locking the resource 1. Still at this time, there is no blocking to those normal codes that do not require access to resources.

Referring to FIG. 5, the synchronization process of the synchronization module 20 of FIG. 2 starts at block 50. At 51, it is determined which synchronization operation should be called and performed. According to an embodiment of the present invention, the synchronization module 20 of FIG. 2 performs this function.

There are three synchronization operations that can be called. These operations are the WAIT operation, the BUSY_WAIT operation, and the TRY_LOCK operation. The WAIT operation is an operation that waits for the release of the resource being accessed by other requesting routine(s) so that the present requesting routine can access the resource. In addition, the WAIT operation gives other routines a chance to access the resource first.

The BUSY_WAIT operation also waits for the release of the resource being accessed by other requesting routine(s), but it does not voluntarily give other routines a chance to have their accesses first. This means that the BUSY_WAIT operation will force the hardware 15 of the computer system 10 (FIG. 2) to frequently check if the resource is released or otherwise available.

The TRY_LOCK operation is an operation that tests the resource to see if it is being accessed by another program routine. If the resource is not being accessed, then the TRY_LOCK operation causes the resource to be acquired.

At 52, the WAIT synchronization operation is called and performed. According to an embodiment of the present invention, the synchronization module 20 of FIG. 2 performs this function. The process then moves to block 55.

The BUSY_WAIT synchronization operation is called and performed. According to an embodiment of the present invention, the synchronization module 20 of FIG. 2 performs this function. The process then moves to block 55.

At 54, the TRY_LOCK synchronization operation is called and performed. According to an embodiment of the present invention, the synchronization module 20 of FIG. 2 performs this function. The process then moves to block 55.

At 55, a SIGNAL operation is called and performed to restore the access indicator of the accessed resource. The synchronization module 20 of FIG. 2 uses the SIGNAL operation to restore the access indicator of the accessed resource. This means that the value of the access indicator is increased by ONE. According to an embodiment of the present invention, the synchronization module 20 of FIG. 2 performs this function. The process then ends at block 56.

The actual implementation of these operations (i.e., WAIT, BUSY_WAIT, TRY_LOCK, and SIGNAL) is dependent on the platform hardware 15 (FIG. 2). This means that the implementation of these operations vary from platform to platform. However, the basic rule is that these operations must be implemented atomic. In an embodiment, the platform hardware 15 includes a 32-bit processor manufactured and marketed by Intel Corporation of Santa Clara, Calif. In this case, the above four operations can be implemented using the DEC, INC, MOV, and XCHG atomic instructions.

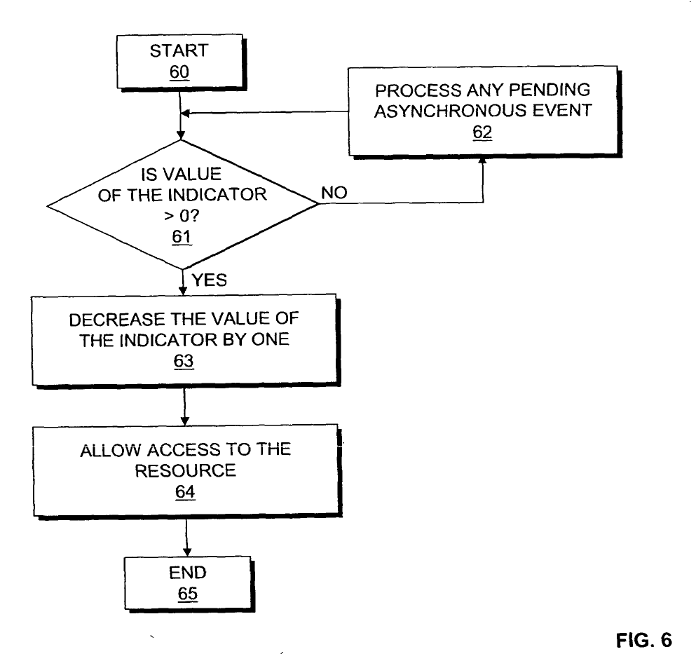

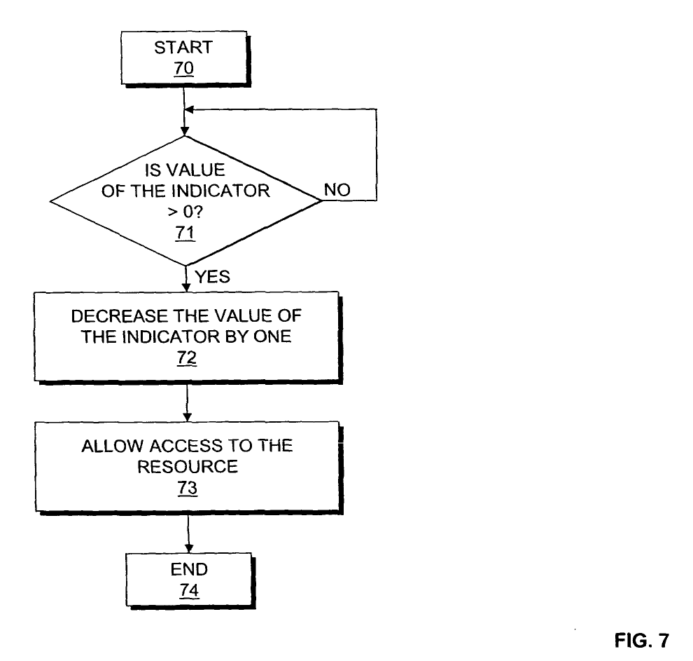

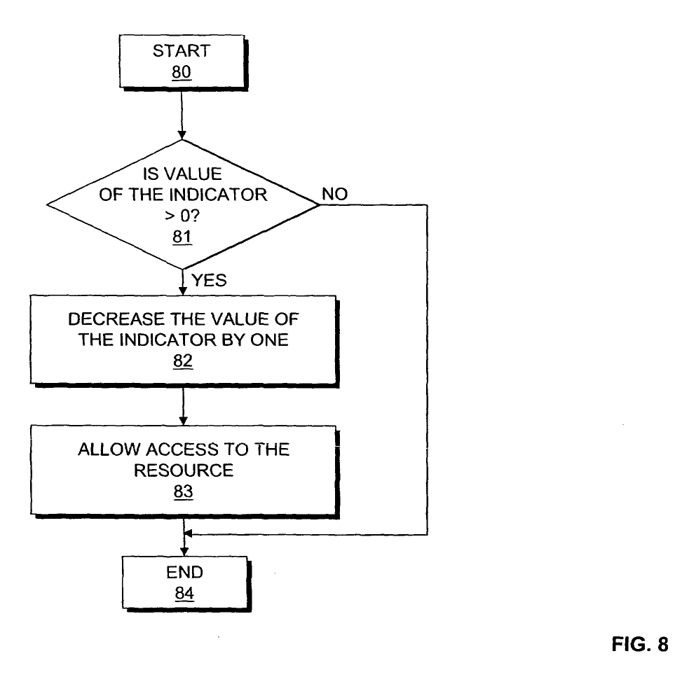

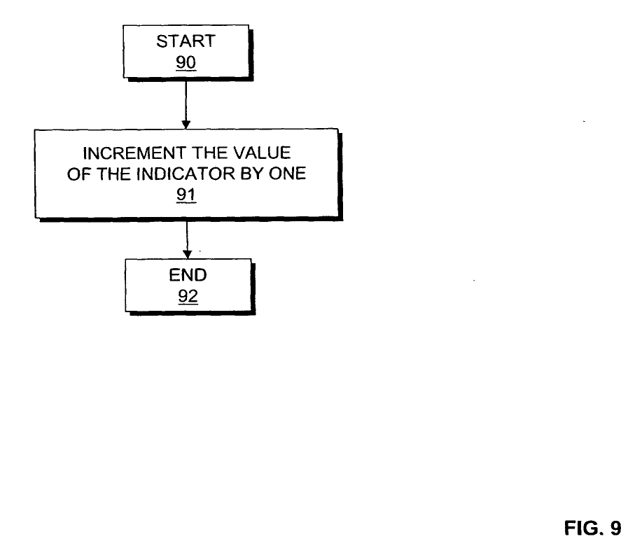

FIG. 6 shows in more detail the WAIT operation of FIG. 5. FIG. 7 shows in more detail the BUSY_WAIT operation of FIG. 5. FIG. 8 shows in more detail the TRY_LOCK operation of FIG. 5. FIG. 9 shows in more detail the SIGNAL operation of FIG. 5. FIGS. 6-9 will be described in more detail below.

Referring to FIG. 6, the WAIT operation starts at block 60. At 61, it is determined whether the value of the access indicator of the resource to be accessed is greater than ZERO. According to one embodiment of the present invention, the synchronization module 20 of FIG. 2 performs this function. If the determination is negative (i.e., NO), it means that the access indicator indicates that the associated resource cannot be accessed at this time. This could mean that the resource is being accessed by another routine. In this case, the process goes to block 62. Otherwise, the process moves to block 63.

At 62, the synchronization module 20 of FIG. 2 waits for any pending access to be completed. In accordance with one embodiment of the present invention, the synchronization module 20 of FIG. 2 performs this function. As described above, this allows other routine a chance to access the resource first.

At 63, the value of the access indicator is decreased by ONE. In accordance with one embodiment of the present invention, the synchronization module 20 of FIG. 2 performs this function.

At 64, the requesting routine is allowed to access the resource. In accordance with an embodiment of the present invention, the synchronization module 20 of FIG. 2 performs this function. The process then ends at block 65.

Referring to FIG. 7, the BUSY_WAIT operation starts at block 70. At 71, it is determined whether the value of the access indicator of the resource to be accessed is greater than ZERO. According to one embodiment of the present invention, the synchronization module 20 of FIG. 2 performs this function. If the determination is negative (i.e., NO), it means that the access indicator indicates that the associated resource cannot be accessed at this time. This could mean that the resource is being accessed by another routine. In this case, the process returns to block 71 until the value of the access indicator is greater than ZERO. Otherwise, the process moves to block 72.

At 72, the value of the access indicator is decreased by ONE. In accordance with one embodiment of the present invention, the synchronization module 20 of FIG. 2 performs this function.

At 73, the requesting routine is allowed to access the resource. In accordance with an embodiment of the present invention, the synchronization module 20 of FIG. 2 performs this function. The process then ends at block 74.

As can be seen from FIG. 8, the TRY_LOCK operation starts at block 80. At 81, it is determined whether the value of the access indicator of the resource to be accessed is greater than ZERO. According to one embodiment of the present invention, the synchronization module 20 of FIG. 2 performs this function. If the determination is negative (i.e., NO), it means that the access indicator indicates that the associated resource cannot be accessed at this time. This could mean that the resource is being accessed by another routine. In this case, the process ends at block 84. Otherwise, the process moves to block 82.

At 82, the value of the access indicator is decreased by ONE. In accordance with one embodiment of the present invention, the synchronization module 20 of FIG. 2 performs this function.

At 83, the requesting routine is allowed to access the resource. In accordance with an embodiment of the present invention, the synchronization module 20 of FIG. 2 performs this function. The process then ends at block 84.

FIG. 9 shows the SIGNAL operation of the synchronization process of FIG. 5. As described above, the SIGNAL operation restores the value of the access indicator of the accessed resource after the associated resource has been accessed. As can be seen from FIG. 9, the SIGNAL operation starts at block 90. At 91, the value of the access indicator is restored to the pre-access value. This means that when one requesting routine has completed its access operation to a resource, the value of the associated access indicator is increased by ONE. If two requesting routines have completed their access to the associated resource, then the value of the access indicator is increased by ONE and then by another ONE. This is basically a notification function, notifying other routines that are waiting to access the resource that the resource is ready to be accessed now. According to an embodiment of the present invention, the synchronization module 20 of FIG. 2 performs this function. The process then ends at block 92.

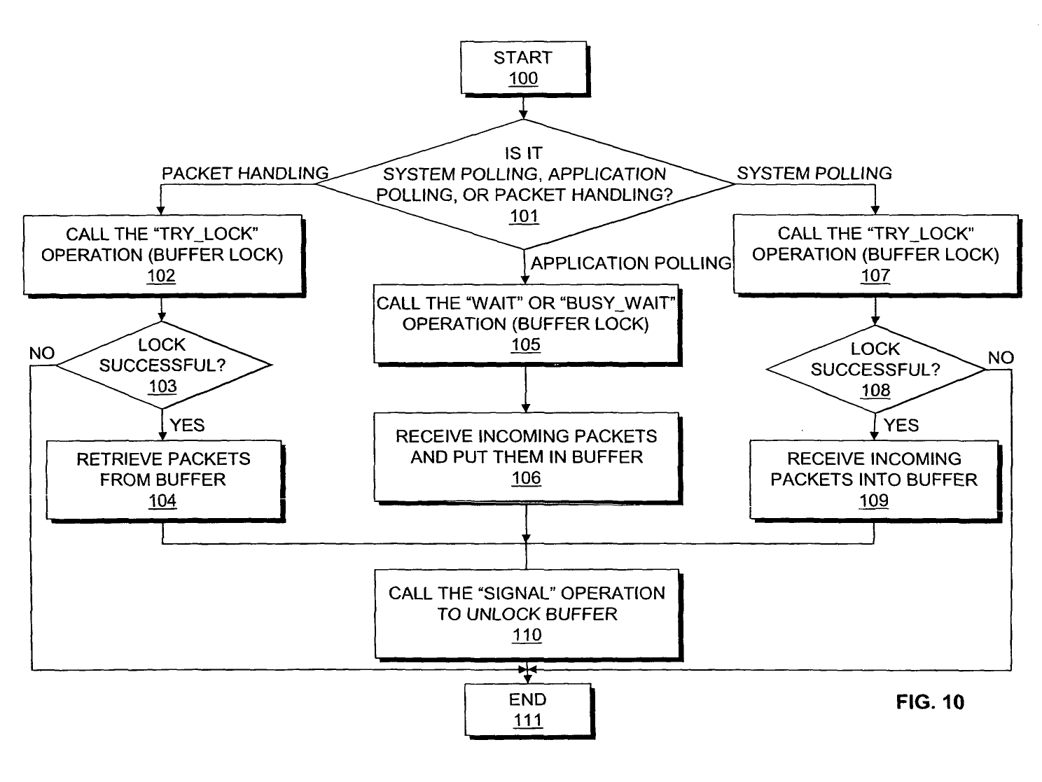

FIG. 10 shows an example of the synchronization process of FIG. 5 performed by the synchronization module 20 of FIG. 2 in handling network communications. In an embodiment, the network communications refer to TCP/IP protocol communications. In this case, the EFI-based BIOS 14 of FIG. 2 includes a set of drivers (not shown in FIG. 2) that are referred to as TCP/IP protocol suites or stack. The EFI-based BIOS 14 calls the stack when the computer system 10 (FIG. 2) wants to conduct communication with heterogeneous computers or the Internet.

The TCP/IP protocol stack, when in operation, needs to access a shared buffer (not shown in FIG. 2) within a network interface card (not shown in FIG. 2) of the platform-specific firmware and hardware 15. The buffer is used to store data packets received from external network (not shown in FIG. 2) and/or data packets of the computer system 10 of FIG. 2 to be sent to the external network. The routines within the TCP/IP protocol stack access this buffer by generating a buffer access request. The synchronization module 20 of FIG. 2 then synchronizes these buffer access requests from the TCP/IP protocol stack.

These routines include a packet handling routine that retrieves data packets from the buffer, an application polling routing that polls the network interface card to place incoming data packets into the buffer, and a system polling routine that polls the network interface card to place incoming data packets into the buffer. In one embodiment, in order to avoid the possibility of any potential deadlock situation, only the application polling routine is allowed to use the WAIT and BUSY_WAIT operation on a single processor. Alternatively, this restriction does not apply.

According to an embodiment of the present invention and as can be seen from FIG. 10, the synchronization process for the TCP/IP protocol stack starts at 100. At 101, it is determined whether the buffer access request comes from a system polling routine, an application polling routine, or a packet handling routine. In accordance with an embodiment of the present invention, the synchronization module 20 of FIG. 2 performs this determination. If the determination is that the routine is a packet handling routine, then the process moves to block 102. If the determination is that the routine is an application polling routine, the process moves to block 105. If the determination is that the routine is a system polling routine, then the process moves to block 107.

At 102, the TRY_LOCK operation is called to lock the buffer. This means to reduce the value of the access indicator for the buffer. In accordance with one embodiment of the present invention, the synchronization module 20 of FIG. 2 performs this function.

At 103, it is determined whether the lock is successful. The lock will be successful if the resource can be locked and acquired. The lock will be unsuccessful if the resource cannot be accessed at this time. In accordance with an embodiment of the present invention, the synchronization module 20 of FIG. 2 performs this determination. If the determination is that the lock is successful at 103, then the process moves to block 104.

At 104, the packet handling routine is allowed to access the buffer to retrieve data packets. In accordance with an embodiment of the present invention, the synchronization module 20 of FIG. 2 performs this function. The process then moves to block 110.

If the lock is determined not to be successful at 103 (i.e., NO), it means that the buffer cannot be accessed (e.g., the value of the access indicator is current at ZERO). In this case, the process ends at block 111.

At 105, the BUSY_WAIT or WAIT operation is called to lock the buffer. This means to reduce the value of the access indicator for the buffer. Here, either the WAIT or BUSY_WAIT operation can be employed. But it is more efficient to use the WAIT operation in a single processor environment. In accordance with one embodiment of the present invention, the synchronization module 20 of FIG. 2 performs this function.

At 106, the application polling routine is allowed to access the buffer to place incoming data packets into the buffer. In accordance with an embodiment of the present invention, the synchronization module 20 of FIG. 2 performs this function. The process then moves to block 110.

At 107, the TRY_LOCK operation is called to lock the buffer. This means to reduce the value of the access indicator for the buffer. In accordance with an embodiment of the present invention, the synchronization module 20 of FIG. 2 performs this function.

At 108, it is determined whether the lock is successful. The lock will be successful if the resource can be locked and acquired. The lock will be unsuccessful if the resource cannot be accessed at this time. In accordance with an embodiment of the present invention, the synchronization module 20 of FIG. 2 performs this determination. If the determination is that the lock is successful at 108, then the process moves to block 109.

At 109, the system polling routine is allowed to access the buffer to place incoming data packets into the buffer. In accordance with an embodiment of the present invention, the synchronization module 20 of FIG. 2 performs this function. The process then moves to block 110.

If the lock is determined not to be successful at 108 (i.e., NO), it means that the buffer cannot be accessed (e.g., the value of the access indicator is current at ZERO). In this case, the process ends at block 111.

At 110, the SIGNAL operation is called to unlock the buffer. In accordance with an embodiment of the present invention, the synchronization module 20 of FIG. 2 performs this function. The process then ends at block 111.

FIGS. 5-10 are flow charts illustrating synchronization processes of the synchronization system 20 of FIG. 2 in synchronizing various requests to access protected global data according to embodiments of the present invention. Some of the procedures illustrated in the figures may be performed sequentially, in parallel or in an order other than that which is described. It should be appreciated that not all of the procedures described are required, that additional procedures may be added, and that some of the illustrated procedures may be substituted with other procedures.

In the foregoing specification, the embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

What is claimed is:

1. A basic input and output system (BIOS) for a computer system, comprising:
a main engine to call and run routines, wherein some of the routines require resource accesses; and
a synchronization module to synchronize the resource accesses, wherein the synchronization module allows concurrent resource accesses to different resources.

2. The BIOS of claim 1, further comprising an access indicator associated with each of the resources to be accessed, wherein the access indicator controls access to its associated resource and does not affect access to another resource.

3. The BIOS of claim 2, wherein when a routine wants to access one of the resources, the synchronization module decreases the value of the access indicator of that one of the resources by a predetermined amount before allowing the routine to access the one of the resources.

4. The BIOS of claim 2, wherein if the value of the access indicator of the one of the resources is equal to zero, that one of the resources is not accessible by any other routine.

5. The BIOS of claim 2, wherein the access indicator and the synchronization module allow concurrent accesses to one of the resources by multiple routines when the access indicator of the one of the resources is assigned with a value greater than one.

6. The BIOS of claim 5, wherein the concurrent accesses to one of the resources by multiple routines are read/write operations to that one of the resources.

7. The BIOS of claim 2, wherein the access indicator and the synchronization module allow anyone of the routines that does not require resource access to be running concurrently with the resource accesses.

8. The BIOS of claim 1, wherein the BIOS is an EFI (Extensible Firmware Interface) based BIOS.

9. A method of synchronizing resource accesses in a basic input and output system (BIOS) of a computer system, comprising:
associating an access indicator with each of a plurality of resources;
determining what current value an access indicator of a resource has when a routine wants to access that resource, wherein the value of the access indicator indicates how many routines are allowed to access the resource concurrently; and
changing the value of the access indicator by a predetermined amount and granting access to the resource to the requesting routine if the value is not at a predetermined level.

10. The method of claim 9, wherein the access indicator of each of the resources is assigned with an initial value.

11. The method of claim 9, further comprising not changing the value of the access indicator and not granting access to the resource to the requesting routine if the value of the access indicator is determined to be already at the predetermined level.

12. The method of claim 11, wherein the changing is performed by decreasing the value of the access indicator by the predetermined amount and granting access to the resource to the requesting routine if the value is not at a predetermined lowest level, wherein the access to the resource by the requesting routine does not affect operation of any other routine that does not require access to this resource.

13. The method of claim 12, wherein the predetermined lowest level is zero and the predetermined amount is one.

14. The method of claim 12, further comprising increasing the value of the access indicator by the predetermined amount after the routine has accessed the resource.

15. The method of claim 9, wherein the BIOS is an EFI (Extensible Firmware Interface) based BIOS.

16. An article of manufacture comprising a machine accessible medium including sequences of instructions, the sequences of instructions including instructions which, when executed, cause the machine to perform:
associating an access indicator with each of a plurality of resources;
determining what current value an access indicator of a resource has when a routine wants to access that resource, wherein the value of the access indicator indicates how many routines are allowed to access the resource concurrently; and
changing the value of the access indicator by a predetermined amount and granting access to the resource to the requesting routine if the value is not at a predetermined level.

17. The article of manufacture of claim 16, wherein the access indicator of each of the resources is assigned with an initial value.

18. The article of manufacture of claim 16, further comprising not changing the value of the access indicator and not granting access to the resource to the requesting routine if the value of the access indicator is determined to be already at the predetermined level, wherein the access to the resource by the requesting routine does not affect operation of any other routine that does not require access to this resource.

19. The article of manufacture of claim 18, wherein the changing is performed by decreasing the value of the access indicator by the predetermined amount and granting access to the resource to the requesting routine if the value is not at a predetermined lowest level.

20. The article of manufacture of claim 19, wherein the predetermined lowest level is zero and the predetermined amount is one.

21. The article of manufacture of claim 19, further comprising increasing the value of the access indicator by the predetermined amount after the routine has accessed the resource.

22. The article of manufacture of claim 16, wherein the instructions are within an EFI (Extensible Firmware Interface) based BIOS (Basic Input Output System).
